(19) United States
(12) Patent Application Publication
(10) Pub. No.: US 2019/0340499 A1
(43) Pub. Date: Nov. 7, 2019

(54) QUANTIZATION FOR DNN ACCELERATORS

(71) Applicant: Microsoft Technology Licensing, LLC, Redmond, WA (US)

(72) Inventors: Douglas C. Burger, Bellevue, WA (US); Eric S. Chung, Woodinville, WA (US); Bita Darvish Rouhani, La Jolla, CA (US); Daniel Lo, Bothell, WA (US); Ritchie Zhao, Ithaca, NY (US)

(73) Assignee: Microsoft Technology Licensing, LLC, Redmond, WA (US)

(21) Appl. No.: 15/972,048

(22) Filed: May 4, 2018

(51) Int. Cl. G06N 3/063; G06N 3/08; G06F 7/483

(52) U.S. Cl. CPC G06N 3/063; G06F 2207/4824; G06F 7/483; G06N 3/08

(57) ABSTRACT

Methods and apparatus are disclosed for providing emulation of quantized precision operations. In some examples, the quantized precision operations are performed for neural network models. Parameters of the quantized precision operations can be selected to emulate operation of hardware accelerators adapted to perform quantized format operations. In some examples, the quantized precision operations are performed in a block floating-point format where one or more values of a tensor, matrix, or vectors share a common exponent. Techniques for selecting the exponent, reshaping the input tensors, and training neural networks for use with quantized precision models are also disclosed. In some examples, a neural network model is further retrained based on the quantized model. For example, a normal precision model or a quantized precision model can be retrained by evaluating loss induced by performing operations in the quantized format.

### BACKGROUND

Machine learning (ML) and artificial intelligence (AI) techniques can be useful for solving a number of complex computational problems such as recognizing images and speech, analyzing and classifying information, and performing various classification tasks. Machine learning is a field of computer science that uses statistical techniques to give computer systems the ability to extract higher-level features from a set of training data. Specifically, the features can be extracted by training a model such as an artificial neural network (NN) or a deep neural network (DNN). After the model is trained, new data can be applied to the model and the new data can be classified (e.g., higher-level features can be extracted) using the trained model. Machine learning models are typically executed on a general-purpose processor (also referred to as a central processing unit (CPU)). However, the models can be computationally expensive and so it may not be possible to perform feature extraction in real-time using general-purpose processors. Accordingly, there is ample opportunity for improvements in computer hardware and software to implement neural networks.

### SUMMARY

Methods and apparatus are disclosed for providing emulation of quantized precision operations. In some examples, the quantized precision operations are performed for neural network models. Parameters of the quantized precision operations can be selected to emulate operation of hardware accelerators adapted to perform quantized format operations. In some examples, the quantized precision operations are performed in a block floating-point format where one or more values of a tensor, matrix, or vectors share a common exponent. Techniques for selecting the exponent, reshaping the input tensors, and training neural networks for use with quantized precision models are also disclosed.

In some examples of the disclosed technology, a quantization-enabled system for modeling a neural network includes memory, one or more general-purpose processors coupled to the memory, and computer readable storage media storing instructions that cause the system to perform methods of training and evaluating neural networks. The operations performed can include evaluating the neural network that has its node weights, edges, and/or activation values stored in memory as normal-precision floating-point format numbers. The method further includes converting at least one of the tensors of the neural network to quantized values, for example to a block floating-point format. At least one mathematical operation is performed with the quantized model, thereby producing modified tensors. The method can convert the modified tensors to a normal precision floating-point format for further evaluation. In some examples, a neural network model is further retrained based on the quantized model. For example, a normal precision model or a quantized precision model can be retrained by evaluating loss induced by performing operations in the quantized format.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, any trademarks used herein remain the property of their respective owners. The foregoing and other objects, features, and advantages of the disclosed embodiments will become more apparent from the following detailed description, which proceeds with reference to the accompanying figures.

### BRIEF DESCRIPTION OF THE DRAWINGS

FIG. 1 is a block diagram of a quantization-enabled system, as can be implemented in certain examples of the disclosed technology.

FIG. 2 is a diagram depicting a deep neural network, as can be modeled using certain example methods and apparatus disclosed herein.

FIG. 3 is a diagram depicting certain aspects of converting a normal floating-point format to a quantized floating-point format, as can be performed in certain examples of the disclosed technology.

FIG. 4 depicts a number of alternative block floating-point formats that can be used to represent quantized neural network models, as can be used in certain examples of the disclosed technology.

FIG. 5 is a diagram depicting a method of training a neural network for use with a quantized model, as can be implemented in certain examples of the disclosed technology.

FIG. 6 is a diagram depicting a method of training a neural network for use with a quantized model, including quantized training, as can be implemented in certain examples of the disclosed technology.

FIG. 7 is a diagram further detailing methods for performing quantized training, as can be implemented in certain examples of the disclosed technology.

FIG. 8 is a diagram depicting tensor flattening operations, as can be performed in certain examples of the disclosed technology.

FIG. 9 is a flow chart outlining an example method of performing operations with a set of quantized format numbers, as can be performed in certain examples of the disclosed technology.

FIG. 10 as a flow chart outlining an example method of training a neural network model in a quantized-precision format, as can be implemented in certain examples of the disclosed technology.

FIG. 11 is a diagram illustrating an example computing environment in which certain examples of the disclosed technology can be implemented.

FIGS. 12-16 are charts illustrating experimental results that can be observed when performing certain examples of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “perform,” “select,” “receive,” “emit,” “verify,” and “convert” to describe the disclosed methods. These terms are high-level descriptions of the actual operations that are performed. The actual operations that correspond to these terms will vary depending on the particular implementation and are readily discernible by one of ordinary skill in the art having the benefit of the present disclosure.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., computer-readable storage media). The computer-executable instructions can be part of, for example, a dedicated software application, or a software application that is accessed or downloaded via a web browser or other software application (such as a remote computing application). Such software can be executed, for example, on a single local computer (e.g., with general-purpose and/or specialized processors executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### II. Introduction to the Neural Networks and Ouantized Formats

Artificial Neural Networks (ANNs or as used throughout herein, “NNs”) are applied to a number of applications in Artificial Intelligence and Machine Learning including image recognition, speech recognition, search engines, and other suitable applications. The processing for these applications may take place on individual devices such as personal computers or cell phones, but it may also be performed in large datacenters. At the same time, hardware accelerators that can be used with NNs include specialized NN processing units, such as tensor processing units (TPUs) and Field Programmable Gate Arrays (FPGAs) programmed to accelerate neural network processing. Such hardware devices are being deployed in consumer devices as well as in data centers due to their flexible nature and low power consumption per unit computation.

Traditionally NNs have been trained and deployed using single-precision floating-point (32-bit floating-point or float32 format). However, it has been shown that lower precision floating-point formats, such as 16-bit floating-point (float16) or fixed-point can be used to perform inference operations with minimal loss in accuracy. On specialized hardware, such as FPGAs, reduced precision formats can greatly improve the latency and throughput of DNN processing.

Numbers represented in normal-precision floating-point format (e.g., a floating-point number expresses in a 16-bit floating-point format, a 32-bit floating-point format, a 64-bit floating-point format, or an 80-bit floating-point format) can be converted to quantized-precision format numbers may allow for performance benefits in performing operations. In particular, NN weights and activation values can be represented in a lower-precision quantized format with an acceptable level of error introduced. Examples of lower-precision quantized formats include formats having a reduced bit width (including by reducing the number of bits used to represent a number's mantissa or exponent) and block floating-point formats where two or more numbers share the same single exponent.

One of the characteristics of computation on an FPGA device is that it typically lacks hardware floating-point support. Floating-point operations may be performed at a penalty using the flexible logic, but often the amount of logic needed to support floating-point is prohibitive in FPGA implementations. Some newer FPGAs have been developed that do support floating-point computation, but even on these the same device can produce twice as many computational outputs per unit time as when it is used in an integer mode. Typically, NNs are created with floating-point computation in mind, but when an FPGA is targeted for NN processing it would be beneficial if the neural network could be expressed using integer arithmetic. Examples of the disclosed technology include hardware implementations of block Floating-point (BFP), including the use of BFP in NN, FPGA, and other hardware environments.

A typical floating-point representation in a computer system consists of three parts: sign (s), exponent (e), and mantissa (m). The sign indicates if the number is positive or negative. The exponent and mantissa are used as in scientific notation:

Value=s×m×2^{e}

Any number may be represented, within the precision limits of the mantissa. Since the exponent scales the mantissa by powers of 2, just as the exponent does by powers of 10 in scientific notation, the magnitudes of very large numbers may be represented. The precision of the representation is determined by the precision of the mantissa. Typical floating-point representations use a mantissa of 10 (float 16), 24 (float 32), or 53 (float64) bits in width. An integer with magnitude greater than 2⁵³ can be approximated in a float64 floating-point format, but it will not be represented exactly because there are not enough bits in the mantissa. A similar effect can occur for arbitrary fractions where the fraction is represented by bits of the mantissa that take on the value of negative powers of 2. There are many fractions that cannot be exactly represented because they are irrational in a binary number system. More exact representations are possible in both situations, but they may require the mantissa to contain more bits. Ultimately, an infinite number of mantissa bits are required to represent some numbers exactly (e.g., ⅓=0.3̅; 22/7=3.1̅4̅2̅8̅5̅7̅). The 10-bit (half precision float), 24-bit (single precision float), and 53-bit (double precision float) mantissa limits are common compromises of mantissa storage requirements versus representation precision in general-purpose computers.

With block floating-point formats, a group of two or more numbers use a single shared exponent with each number still having its own sign and mantissa. In some examples, the shared exponent is chosen to be the largest exponent of the original floating-point values. For purposes of the present disclosure, the term block floating-point (BFP) means a number system in which a single exponent is shared across two or more values, each of which is represented by a sign and mantissa pair (whether there is an explicit sign bit, or the mantissa itself is signed).

In some examples, all values of one or more rows or columns of a matrix or vector, or all values of a matrix or vector, can share a common exponent. In other examples, the BFP representation may be unsigned. In some examples, some but not all of the elements in a matrix or vector BFP representation may include numbers represented as integers, floating-point numbers, fixed point numbers, symbols, or other data formats mixed with numbers represented with a sign, mantissa, and exponent. In some examples, some or all of the elements in a matrix or vector BFP representation can include complex elements having two or more parts, for example: complex numbers with an imaginary component (a+bi, where i=\sqrt{−1}); fractions including a numerator and denominator, in polar coordinates (r, θ), or other multi-component element.

BFP formats can be used to tradeoff precision and storage requirements, in a fashion that is similar in some respects to normal floating-point. First, rather than storing an exponent with every floating-point number, a group of numbers can share the same exponent. To share exponents while maintaining a high level of accuracy, the numbers should have close to the same magnitude, since differences in magnitude are expressed in the mantissa. If the differences in magnitude are too great, the mantissa will overflow for the large values, or may be zero (“underflow”) for the smaller values. Depending on a particular application, some amount of overflow and/or underflow may be acceptable.

The size of the mantissa can be adjusted to fit a particular application. This can affect the precision of the number being represented, but potential gains are realized from a reduced representation size. For example, a normal single-precision float has a size of four bytes, but for certain implementations of the disclosed technology, only two bytes are used to represent the sign and mantissa of each value.

In certain examples of the disclosed technology, the representation expressed above is used to derive the original number from the representation, but only a single exponent is stored for a group of numbers, each of which is represented by a signed mantissa. Each signed mantissa can be represented by two bytes or less, so in comparison to four-byte floating-point, the memory storage savings is about 2×. Further, the memory bandwidth requirements of loading and storing these values are also approximately one-half that of normal floating-point.

Neural network operations are used in many artificial intelligence operations. Often, the bulk of the processing operations performed in implementing a neural network is in performing Matrix×Matrix or Matrix×Vector multiplications. Such operations are compute- and memory-bandwidth intensive, where the size of a matrix may be, for example, 1000×1000 elements (e.g., 1000×1000 numbers, each including a sign, mantissa, and exponent) or larger and there are many matrices used. As discussed herein, BFP techniques can be applied to such operations to reduce the demands for computation as well as memory bandwidth in a given system, whether it is an FPGA, CPU or another hardware platform. As used herein, the use of the term “element” herein refers to a member of such a matrix or vector.

As used herein, the term “tensor” refers to a multi-dimensional array that can be used to represent properties of a NN and includes one-dimensional vectors as well as two-, three-, four-, or larger dimension matrices. As used in this disclosure, tensors do not require any other mathematical properties unless specifically stated.

As used herein, the term “normal-precision floating-point” refers to a floating-point number format having a mantissa, exponent, and optionally a sign and which is natively supported by a native or virtual CPU. Examples of normal-precision floating-point formats include, but are not limited to, IEEE 754 standard formats such as 16-bit, 32-bit, 64-bit, or to other processors supported by a processor, such as Intel AVX, AVX2, IA32, and x86_64 80-bit floating-point formats.

As used herein, the term “quantized-precision floating-point” refers to a floating-point number format where two or more values of a tensor have been modified to emulate neural network hardware. In particular, many examples of quantized-precision floating-point representations include block floating-point formats, where two or more values of the tensor are represented with reference to a common exponent. The quantized-precision floating-point number can be generated by selecting a common exponent for two, more, or all elements of a tensor and shifting mantissas of individual elements to match the shared, common exponent. In some examples, groups of elements within a tensor can share a common exponent on, for example, a per-row, per-column, per-tile, or other basis.

### III. Introduction to the Disclosed Technology

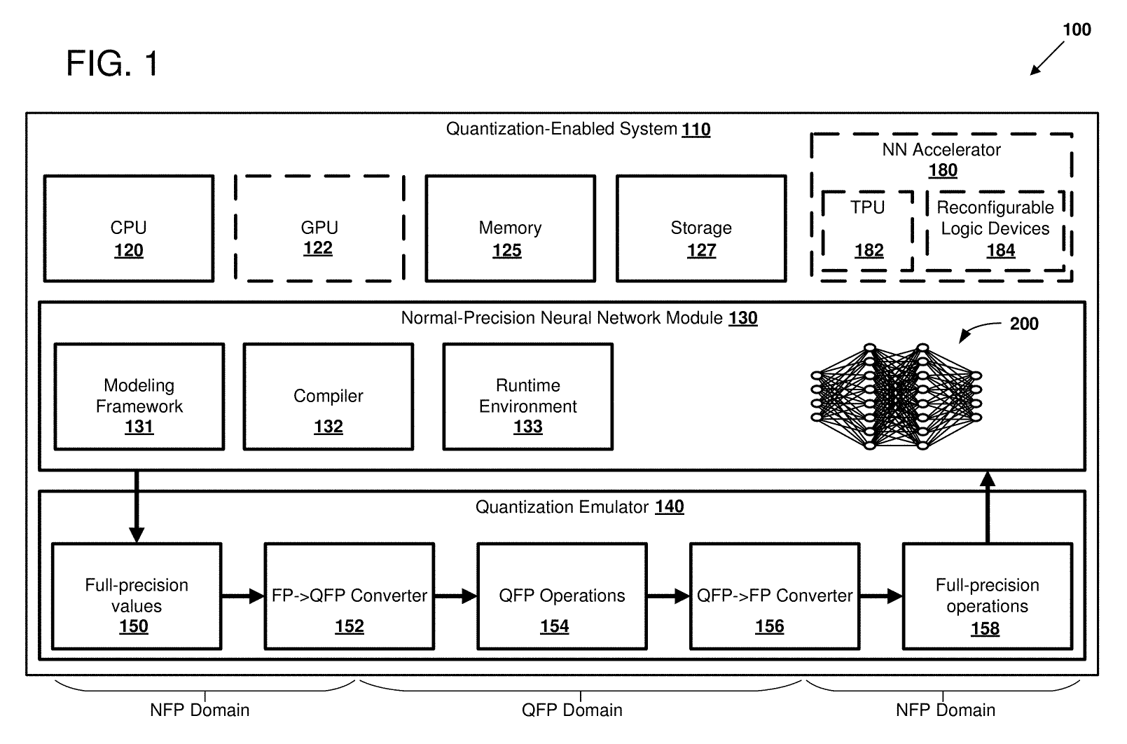

FIG. 1 is a block diagram 100 outlining an example quantization-enabled system 110 as can be implemented certain examples of the disclosed technology. As shown in FIG. 1, the quantization-enabled system 110 can include a number of hardware resources including general-purpose processors 120 and special-purpose processors such as graphics processing units 122. The processors are coupled to memory 125 and storage 127, which can include volatile or non-volatile memory devices. The processors 120 and 122 execute instructions stored in the memory or storage in order to provide a normal-precision neural network module 130. The normal-precision neural network module 130 includes software interfaces that allow the system to be programmed to implement various types of neural networks. For example, software functions can be provided that allow applications to define neural networks including weights, activation values, and interconnections between layers of a neural network. Define state elements for recurrent neural networks. The normal-precision neural network module 130 can further provide utilities to allow for training and retraining of a neural network implemented with the module. Values representing the neural network module are stored in memory or storage and are operated on by instructions executed by one of the processors.

In some examples, proprietary or open source libraries or frameworks are provided to a programmer to implement neural network creation, training, and evaluation. Examples of such libraries include TensorFlow, Microsoft Cognitive Toolkit (CNTK), Caffe, Theano, and Keras. In some examples, programming tools such as integrated development environments provide support for programmers and users to define, compile, and evaluate NNs.

The quantization-enabled system 110 further includes a quantization emulator 140. The quantization emulator 140 provides functionality that can be used to convert data represented in full precision floating-point formats in the normal-precision neural network module 130 into quantized format values. Such functionality will be discussed in further detail below.

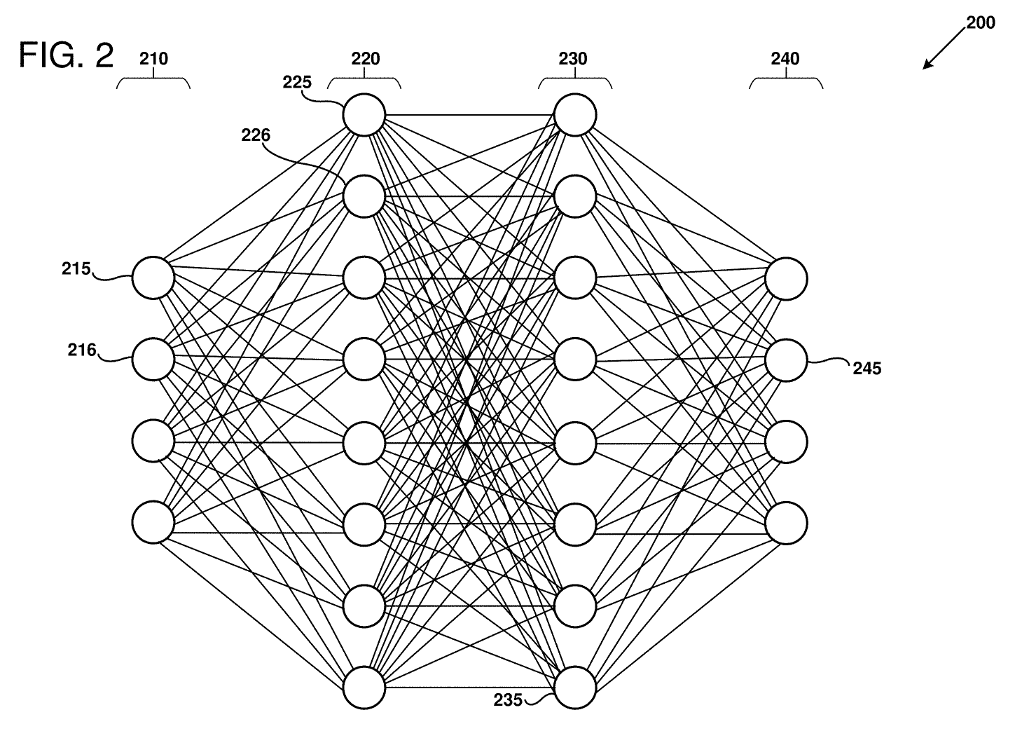

The normal-precision neural network module 130 can be used to specify, train, and evaluate a neural network model using a tool flow that includes a hardware-agnostic modelling framework 131 (also referred to as a native framework or a machine learning execution engine), a neural network compiler 132, and a neural network runtime environment 133. The memory includes computer-executable instructions for the tool flow including the modelling framework 131, the neural network compiler 132, and the neural network runtime environment 133. The tool flow can be used to generate neural network data 200 representing all or a portion of the neural network model, such as the neural network model discussed below regarding FIG. 2. It should be noted that while the tool flow is described as having three separate tools (131, 132, and 133), The tool flow can have fewer or more tools in various examples. For example, the functions of the different tools (131, 132, and 133) can be combined into a single modelling and execution environment.

The neural network data 200 can be stored in the memory 125. The neural network data 200 can be represented in one or more formats. For example, the neural network data 200 corresponding to a given neural network model can have a different format associated with each respective tool of the tool flow. Generally, the neural network data 200 can include a description of nodes, edges, groupings, weights, biases, activation functions, and/or tensor values. As a specific example, the neural network data 200 can include source code, executable code, metadata, configuration data, data structures and/or files for representing the neural network model.

The modelling framework 131 can be used to define and use a neural network model. As one example, the modelling framework 131 can include pre-defined APIs and/or programming primitives that can be used to specify one or more aspects of the neural network model. The pre-defined APIs can include both lower-level APIs (e.g., activation functions, cost or error functions, nodes, edges, and tensors) and higher-level APIs (e.g., layers, convolutional neural networks, recurrent neural networks, linear classifiers, and so forth). “Source code” can be used as an input to the modelling framework 131 to define a topology of the graph of a given neural network model. In particular, APIs of the modelling framework 131 can be instantiated and interconnected within the source code to specify a complex neural network model. A data scientist can create different neural network models by using different APIs, different numbers of APIs, and interconnecting the APIs in different ways.

In addition to the source code, the memory 125 can also store training data. The training data includes a set of input data for applying to the neural network model 200 and a desired output from the neural network model for each respective dataset of the input data. The modelling framework 131 can be used to train the neural network model with the training data. An output of the training is the weights and biases that are associated with each node of the neural network model. After the neural network model is trained, the modelling framework 131 can be used to classify new data that is applied to the trained neural network model. Specifically, the trained neural network model uses the weights and biases obtained from training to perform classification and recognition tasks on data that has not been used to train the neural network model. The modelling framework 131 generally uses only the CPU 120 to execute the neural network model and so it may not achieve real-time performance for some classification tasks. The modelling framework 131 may also support using a GPU 122 to execute the neural network model, but the performance may still not reach real-time performance.

The compiler 132 analyzes the source code and data (e.g., the weights and biases learned from training the model) provided for a neural network model and transforms the model into a format that can be accelerated on the quantized emulator 140 and/or an optional neural network accelerator 180, which will be described in further detail below. Specifically, the compiler 132 transforms the source code into executable code, metadata, configuration data, and/or data structures for representing the neural network model and memory as neural network data 200. In some examples, the compiler 132 can divide the neural network model into portions (e.g., neural network 200) using the CPU 120 and/or the GPU 122) and other portions (e.g., a neural network subgraph) that can be executed on the neural network accelerator 180. The compiler 132 can generate executable code (e.g., runtime modules) for executing subgraphs assigned to the CPU 120 and for communicating with the subgraphs assigned to the optional accelerator 180. The compiler 132 can generate configuration data for the accelerator 180 that is used to configure accelerator resources to evaluate the subgraphs assigned to the optional accelerator 180. The compiler 132 can create data structures for storing values generated by the neural network model during execution and/or training and for communication between the CPU 120 and the accelerator 180. The compiler 132 can generate metadata that can be used to identify subgraphs, edge groupings, training data, and various other information about the neural network model during runtime. For example, the metadata can include information for interfacing between the different subgraphs of the neural network model.

The runtime environment 133 provides an executable environment or an interpreter that can be used to train the neural network model during a training mode and that can be used to evaluate the neural network model in training, inference, or classification modes. During the inference mode, input data can be applied to the neural network model inputs and the input data can be classified in accordance with the training of the neural network model. The input data can be archived data or real-time data.

The runtime environment 133 can include a deployment tool that, during a deployment mode, can be used to deploy or install all or a portion of the neural network to the quantization emulator 140. The runtime environment 133 can further include a scheduler that manages the execution of the different runtime modules and the communication between the runtime modules and the quantization emulator 140. Thus, the runtime environment 133 can be used to control the flow of data between nodes modeled on the normal-precision neural network module 130 and the quantization emulator 140.

The quantization emulator 140 receives normal-precision values 150 from the normal-precision neural network module 130. The normal-precision values can be represented in 16-, 32-, 64-bit, or other suitable floating-point format. For example, a portion of values representing the neural network can be received, including edge weights, activation values, or other suitable parameters for quantization. The normal-precision values 150 are provided to a normal-precision floating-point to quantized floating-point converter 152, which converts the normal-precision value into quantized values. Quantized floating-point operations 154 can then be performed on the quantized values. The quantized values can then be converted back to a normal-floating-point format using a quantized floating-point to normal-floating-point converter which produces normal-precision floating-point values.

The conversions between normal floating-point and quantized floating-point performed by the converters 152 and 156 are typically performed on sets of numbers represented as vectors or multi-dimensional matrices. In some examples, additional normal-precision operations 158, including operations that may be desirable in particular neural network implementations can be performed based on normal-precision formats including adding a bias to one or more nodes of a neural network, applying a hyperbolic tangent function or other such sigmoid function, or rectification functions (e.g., ReLU operations) to normal-precision values that are converted back from the quantized floating-point format.

In some examples, the quantized values are actually stored in memory as normal floating-point values. In other words, the quantization emulator 140 quantizes the inputs, weights, and activations for a neural network model, but the underlying operations are performed in normal floating-point. In other examples, the emulator provides full emulation of quantization, including only storing one copy of the shared exponent and operating with reduced mantissa widths. Some results may differ over versions where the underlying operations are performed in normal floating-point. For example, the full emulation version can check for underflow or overflow conditions for a limited, quantized bit width (e.g., 3, 4, or 5 bit wide mantissas).

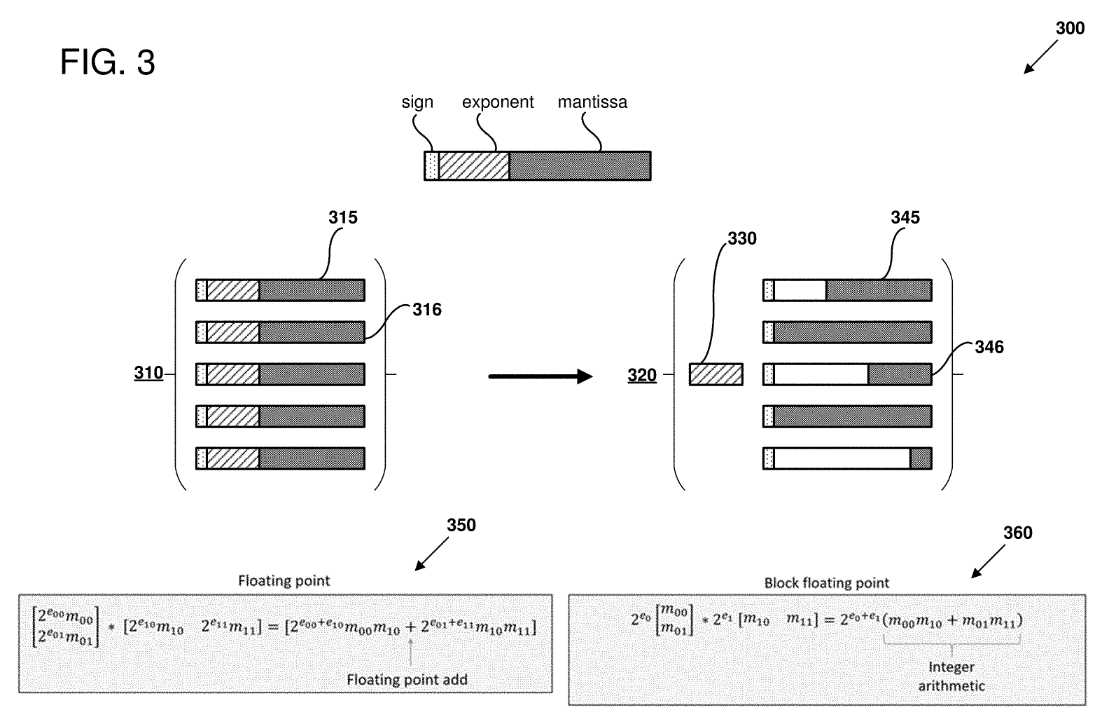

The bulk of the computational cost of DNNs is in matrix-vector and matrix-matrix multiplications. These operations are quadratic in input sizes while operations such as bias add and activation functions are linear in input size. Thus, in some examples, quantization is only applied to matrix-vector multiplication operations, which will be eventually implemented on a NN hardware accelerator, such as a TPU or FPGA. In such examples, all other operations are done in a normal-precision format, such as float16. Thus, from the user or programmer's perspective, the quantization-enabled system 110 accepts and outputs normal-precision float16 values from/to the normal-precision neural network module 130 and output float16 format values. All conversions to and from block floating-point format can be hidden from the programmer or user. In some examples, the programmer or user may specify certain parameters for quantization operations. In other examples, quantization operations can take advantage of block floating-point format to reduce computation complexity, as discussed below regarding FIG. 3.

In certain examples, an optional neural network accelerator 180 is used to accelerate evaluation and/or training of neural network subgraphs, typically with increased speed and reduced latency that is not realized when evaluating the subgraph only on the quantized emulator 140. In the illustrated example, the accelerator includes a Tensor Processing Unit 182 and/or reconfigurable logic devices 184 (e.g., contained in one or more FPGAs or a programmable circuit fabric), however any suitable hardware accelerator can be used that models neural networks. The accelerator 180 can include configuration logic which provides a soft CPU. The soft CPU supervises operation of the accelerated subgraph on the accelerator 180 and can manage communications with the normal-precision neural network module 130 and/or the quantization emulator 140. The soft CPU can also be used to configure logic and to control loading and storing of data from RAM on the accelerator, for example in block RAM within an FPGA.

In some examples, the quantization emulator 140 is used to prototype training, inference, or classification of all or a portion of the neural network model 200. For example, quantization parameters can be selected based on accuracy or performance results obtained by prototyping the network within emulator 140. After a desired set of quantization parameters is selected, a quantized model can be programmed into the accelerator 180 for performing further operations. In some examples, the final quantized model implemented with the emulator 140 is identical to the quantized model that will be programmed into the accelerator 180. In other examples, the model programmed into the accelerator may be different in certain respects.

The compiler 132 and the runtime 133 provide a fast interface between the normal-precision neural network module 130, the quantization emulator 140, and (optionally) the accelerator 180. In effect, the user of the neural network model may be unaware that a portion of the model is being accelerated on the provided accelerator. For example, node values are typically propagated in a model by writing tensor values to a data structure including an identifier. The runtime 133 associates subgraph identifiers with the accelerator, and provides logic for translating the message to the accelerator, transparently writing values for weights, biases, and/or tensors to the quantization emulator 140, and/or (optionally) the accelerator 180, without program intervention. Similarly, values that are output by the quantization emulator 140, and (optionally) the accelerator 180 may be transparently sent back to the normal-precision neural network module 130 with a message including an identifier of a receiving node at the server and a payload that includes values such as weights, biases, and/or tensors that are sent back to the overall neural network model.

### IV. Example Deep Neural Network Topology

FIG. 2 illustrates a simplified topology of a deep neural network (DNN) 200 that can be used to perform enhanced image processing using disclosed BFP implementations. One or more processing layers can be implemented using disclosed techniques for quantized and BFP matrix/vector operations, including the use of one or more of the plurality 210 of neural network cores in the quantization-enabled system 110 described above. It should be noted that applications of the neural network implementations disclosed herein are not limited to DNNs but can also be used with other types of neural networks, such as convolutional neural networks (CNNs), including implementations having Long Short Term Memory (LSTMs) or gated recurrent units (GRUs), or other suitable artificial neural networks that can be adapted to use BFP methods and apparatus disclosed herein.

As shown in FIG. 2, a first set 210 of nodes (including nodes 215 and 216) form an input layer. Each node of the set 210 is connected to each node in a first hidden layer formed from a second set 220 of nodes (including nodes 225 and 226). A second hidden layer is formed from a third set 230 of nodes, including node 235. An output layer is formed from a fourth set 240 of nodes (including node 245). In example 200, the nodes of a given layer are fully interconnected to the nodes of its neighboring layer(s). In other words, a layer can include nodes that have common inputs with the other nodes of the layer and/or provide outputs to common destinations of the other nodes of the layer. In other examples, a layer can include nodes that have a subset of common inputs with the other nodes of the layer and/or provide outputs to a subset of common destinations of the other nodes of the layer.

Each of the nodes produces an output by applying a weight to each input generated from the preceding node and collecting the weights to produce an output value. In some examples, each individual node can have an activation function and/or a bias applied. For example, any appropriately programmed processor or FPGA can be configured to implement the nodes in the depicted neural network 200. In some example neural networks, an activation function ƒ( ) of a hidden combinational node n can produce an output expressed mathematically as:

$$f ( n ) = {\sum }_{i = 0} {w}_{i} {x}_{i} + {b}_{i}$$

where wᵢ is a weight that is applied (multiplied) to an input edge xᵢ, plus a bias value bᵢ. In some examples, the activation function produces a continuous value (represented as a floating-point number) between 0 and 1. In some examples, the activation function produces a binary 1 or 0 value, depending on whether the summation is above or below a threshold.

Neural networks can be trained and retrained by adjusting constituent values of the activation function. For example, by adjusting weights wᵢ or bias values bᵢ for a node, the behavior of the neural network is adjusted by corresponding changes in the networks output tensor values. For example, a cost function C(w, b) can be used to find suitable weights and biases for the network and described mathematically as:

$$C ( w , b ) = \frac{1}{2 n} {\sum }_{x} {\vert \vert y ( x ) - a \vert \vert}^{2}$$

where w and b represent all weights and biases, n is the number of training inputs, a is a vector of output values from the network for an input vector of training inputs x. By adjusting the network weights and biases, the cost function C can be driven to a goal value (e.g., to zero (0)) using various search techniques, for examples, stochastic gradient descent.

Examples of suitable applications for such neural network BFP implementations include, but are not limited to: performing image recognition, performing speech recognition, classifying images, translating speech to text and/or to other languages, facial or other biometric recognition, natural language processing, automated language translation, query processing in search engines, automatic content selection, analyzing email and other electronic documents, relationship management, biomedical informatics, identifying candidate biomolecules, providing recommendations, or other classification and artificial intelligence tasks.

In some examples, a set of parallel multiply-accumulate (MAC) units in each convolutional layer can be used to speed up the computation. Also, parallel multiplier units can be used in the fully-connected and dense-matrix multiplication stages. A parallel set of classifiers can also be used. Such parallelization methods have the potential to speed up the computation even further at the cost of added control complexity.

As will be readily understood to one of ordinary skill in the art having the benefit of the present disclosure, the application of neural network implementations can be used for different aspects of using neural networks, whether alone or in combination or subcombination with one another. For example, disclosed implementations can be used to implement neural network training via gradient descent and/or back propagation operations for a neural network. Further, disclosed implementations can be used for evaluation of neural networks.

### V. Example Block Floating-Point Formats

FIG. 3 is a diagram 300 illustrating an example of converting a normal floating-point format to a quantized, block floating-point format, as can be used in certain examples of the disclosed technology. For example, input tensors for a neural network represented as normal floating-point numbers (for example, in a 32-bit or 16-bit floating-point format) can be converted to the illustrated block floating-point format.

As shown, a number of normal floating-point format numbers 310 are represented such that each number for example number 315 or number 316 include a sign, an exponent, and a mantissa. For example, for IEEE 754 half precision floating-point format, the sign is represented using one bit, the exponent is represented using 5 bits, and the mantissa is represented using 10 bits. When the floating-point format numbers 310 in the neural network model 200 are converted to a set of quantized precision, block floating-point format numbers, there is one exponent value that is shared by all of the numbers of the illustrated set. Thus, as shown, the set of block floating-point numbers 320 are represented by a single exponent value 330, while each of the set of numbers includes a sign and a mantissa. However, since the illustrated set of numbers have different exponent values in the floating-point format, each number's respective mantissa may be shifted such that the same or a proximate number is represented in the quantized format (e.g., shifted mantissas 345 and 346).

Further, as shown in FIG. 3, use of block floating-point format can reduce computational resources required for certain common operations. In the illustrated example, a dot product of two floating-point vectors is illustrated in formal floating-point format (350) and in block floating-point format (360). For numbers represented in the normal-precision floating-point format operation 350, a floating-point addition is required to perform the dot product operation. In a dot product of floating-point vectors, the summation is performed in floating-point which can require shifts to align values with different exponents. On the other hand, for the block floating-point dot product operation 360, the product can be calculated using integer arithmetic to combine mantissa elements as shown. In other words, since the exponent portion can be factored in the block floating-point representation, multiplication in addition of the mantissas can be done entirely with fixed point or integer representations. As a result, large dynamic range for the set of numbers can be maintained with the shared exponent while reducing computational costs by using more integer arithmetic, instead of floating-point arithmetic. In some examples, operations performed by the quantization emulator 140 can be optimized to take advantage of block floating-point format.

In some examples, the shared exponent 330 is selected to be the largest exponent from among the original normal-precision numbers in the neural network model 200. In other examples, the shared exponent may be selected in a different manner, for example, by selecting an exponent that is a mean or median of the normal floating-point exponents, or by selecting an exponent to maximize dynamic range of values stored in the mantissas when their numbers are converted to the quantized number format. It should be noted that some bits of the quantized mantissas may be lost if the shared exponent and the value's original floating-point exponent are not the same. This occurs because the mantissa is shifted to correspond to the new, shared exponent.

### VI. Example Alternatives for Tensor Values that Will Share and Exponent

There are several possible choices for which values in a block floating-point tensor will share an exponent. The simplest choice is for an entire matrix or vector to share an exponent. However, sharing an exponent over a finer granularity can reduce errors because it increases the likelihood of BFP numbers using a shared exponent that is closer to their original normal floating-point format exponent. Thus, loss of precision due to dropping mantissa bits (when shifting the mantissa to correspond to a shared exponent) can be reduced.

For example, consider multiplying a row-vector x by matrix W: y=xW. If an exponent is shared for each column of W, then each dot-product xWⱼ (where Wⱼ is the j-th column of W) only involves one shared exponent for x and one shared exponent for W.

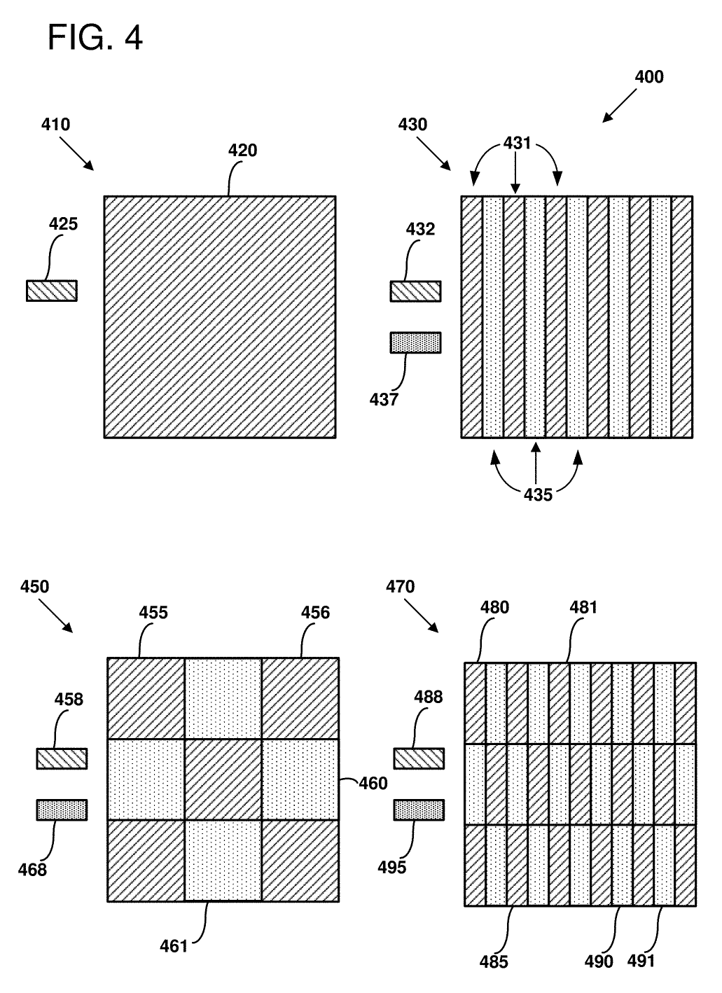

FIG. 4 is a diagram 400 illustrating four alternative block floating-point formats, as can be used in certain examples of the disclosed technology. As shown, a first format 410 represents an entire array 420 of values that share a single exponent 425. In a second format 430, a common exponent is shared on a per-column basis. Thus, in this particular example, block floating-point values stored in even columns 431 of a matrix each share a first, single exponent 432. Block floating-point values stored in odd columns 435 each share a second, single exponent 437. In other examples, each column of an array can be associated with a different shared exponent. For an eleven-column tile in the alternative format, there can be eleven corresponding shared exponents, one shared exponent per column. In other examples, each row of an array can be associated with a different shared exponent, or odd and even rows can be associated with a shared common exponent.

A third format 450 is shown where groups of elements in an array share a common exponent. For example, if a 15×15 matrix of values shares in exponent according to the third format 450, a first set of 5×5 element groups 455 and 456 share a single shared exponent 458. Similarly, a second 5×5 element group of elements in the array 460 and 461 can each shared a second single exponent 468. In other examples, each of the tiles can be associated with its own respective shared exponent. In the example format 450, there could be nine shared exponents for the 15×15 matrix.

A fourth format 470 is shown where two shared exponents are shared on a tiling plus per-column basis. Thus, a first set of numbers including numbers 480, 481, and 485 all share a single common exponent 488. Similarly, a second set of numbers including a set 490 and 491 each share a second, different single exponent 495. In an alternative example, each of the groups shown can have its own shared exponent.

In some examples, the computational cost of matrix-vector multiplication can be further reduced by reducing mantissa widths. A large range of values having a shared common exponent can be expressed with only a few bits of mantissa. for example, in a representation with 4 bits of mantissa and a 5-bit exponent, values can be expressed in a range [2⁻¹⁴0.001₂, 2¹⁵1.111₂], or approximately [2⁻¹⁷, 2¹⁶]. in contrast, a 4-bit fixed point number can only represent values in the range [0001₂, 1111₂], or approximately [2⁰, 2⁴].

### VII. Example Use of Ouantized Neural Network Model

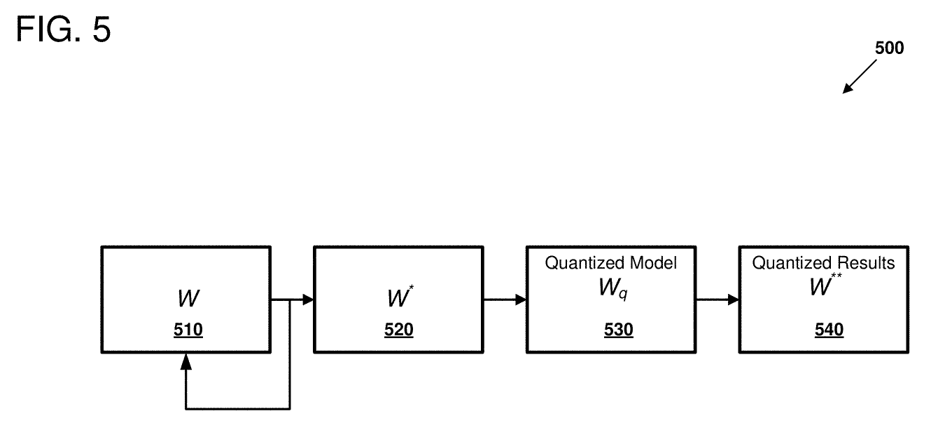

FIG. 5 is a diagram 500 depicting a process of modeling a neural network using numbers stored in a quantized floating-point format, as can be performed in certain examples of the disclosed technology. For example, the quantization-enabled system 110 discussed above regarding FIG. 1 can be used to perform the illustrated modeling process.

As shown in FIG. 5, a neural network represented as a set of pre-trained model values W 510 is provided. The model 510 is trained using, for example, stochastic gradient descent, or other suitable model, producing a trained model W* 520. The pre-trained model W 510 can be designed and trained using normal-precision floating-point numbers. After the neural network has been trained, at least a portion of the neural network trained model W* 520 (comprising one or more input tensor) is converted from its normal-precision floating-point format into a set of quantized precision format numbers. As part of the converting, both model parameters as well as activation values in the neural network are quantized. This converting produces the quantized model W_{q} 530. In some examples, a block floating-point model including at least one single shared exponent is used to represent the quantized precision format numbers. In some examples, a shared exponent is used for the entire tensor. In some examples, a shared exponent is used for two or more columns, two or more rows, or all elements or tiles within an entire tensor. One or more operations can be performed with the set of quantized precision format numbers, for example, inference operations. In some examples, the quantized model 530 is emulated by storing the quantized precision numbers as normal-precision floating-point numbers. As operations are performed with the quantized numbers stored as normal-precision numbers, the modified set of quantized precision format numbers will mimic behavior of a neural network when it is implemented using a hardware accelerator or an FPGA. In other examples, the quantized numbers are stored in the quantized precision format and subsequent operations are emulated using, for example, block floating-point representations with the general-purpose processor.

Performing the operations with the set of quantized precision format numbers produces a modified set of quantized precision format numbers, which are produced as quantized results W** 540. The quantized results can be used to evaluate the effect of quantization on the neural network model. For example, inference validation can be used to compare an expected output for the neural network with the output that is produced using the quantized model W_{q} 530. Additionally, new data sets not used in the training of the model W 510 can be used to determine accuracy of the quantized model.

### VIII. Example Use of Quantized Neural Network Model with Quantized Retraining

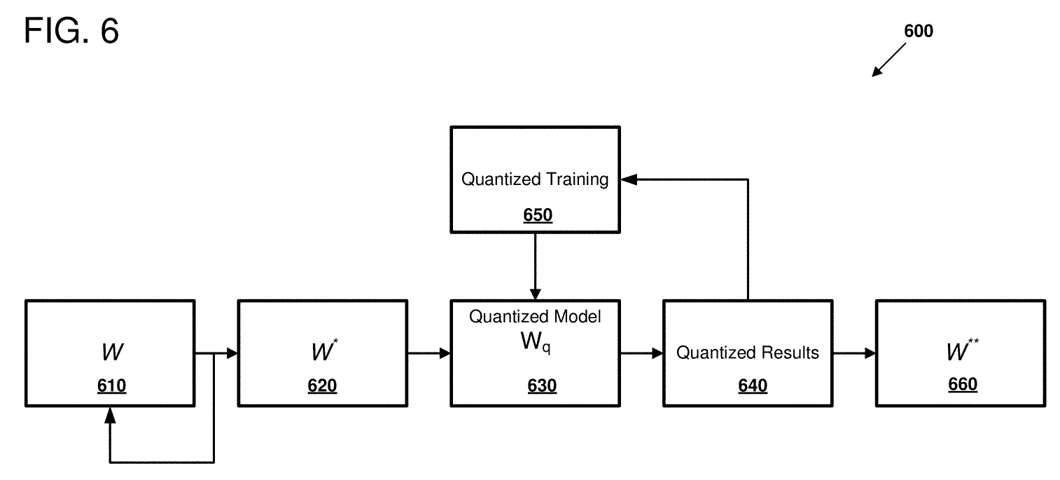

FIG. 6 is a diagram 600 depicting an example of using a quantized neural network model with additional, quantized training. As shown, an input neural network model W 610 is represented as a set of pre-trained model parameters, which has been trained using a normal floating-point representation, to produce a trained neural network model W*, in a similar manner to that discussed above regarding FIG. 5. This trained model W* 620 is quantized to produce a quantized model W_{q} 630. For example, block floating-point numbers can be used to represent neural network nodes and edges in the quantized model 630. In some examples, one or more aspects of the quantization process can be specified by a user or programmer. One or more operations are performed with the quantized model 630, thereby producing quantized results 640. The quantized results can be evaluated by performing inference evaluation with inputs that were used to train the input neural network model W 610. In addition or alternatively, the quantized results 640 can be evaluated by providing new input data to the quantized model 630, and evaluating the accuracy of the results. It should be noted that evaluation of the accuracy of the quantized model can be performed by evaluating the output of the neural model itself, and not by comparing errors within edges or node weights of the neural network.

A programmer or user may determine that the accuracy of the quantized model should be improved. In such a case, quantized training 650 can be performed using the quantized results 640 to fine-tune the quantized model 630. This fine-tuning can be performed by evaluating training data with the quantized model 630 and using losses (or error) from the quantized model in comparison to the normal floating-point based model further train the model. In some examples, parameters used for the fine-tuning training are varied from that used for the floating-point training performed to produce the trained neural network W* 620. For example, the learning rate of the network may be reduced when performing fine-tuning as part of the quantized training 650. After at least one round of fine-tuning to produce an updated quantized model 630, an updated quantized model W** 660 is produced. This updated quantized model 660 can be used to evaluate how the trained model will perform one provided to a neural network hardware accelerator.

Similar to the discussion above regarding FIG. 5, the quantized values may actually be stored in memory as floating-point numbers, but that have been modified to appear quantized to the underlying neural network run time. In some examples, the quantized values are actually stored in memory as block floating-point numbers, and a library of neural network operations as provided to operate on the quantized values as if the neural network was implemented using a hardware accelerator.

### IX. Example of Ouantized Training

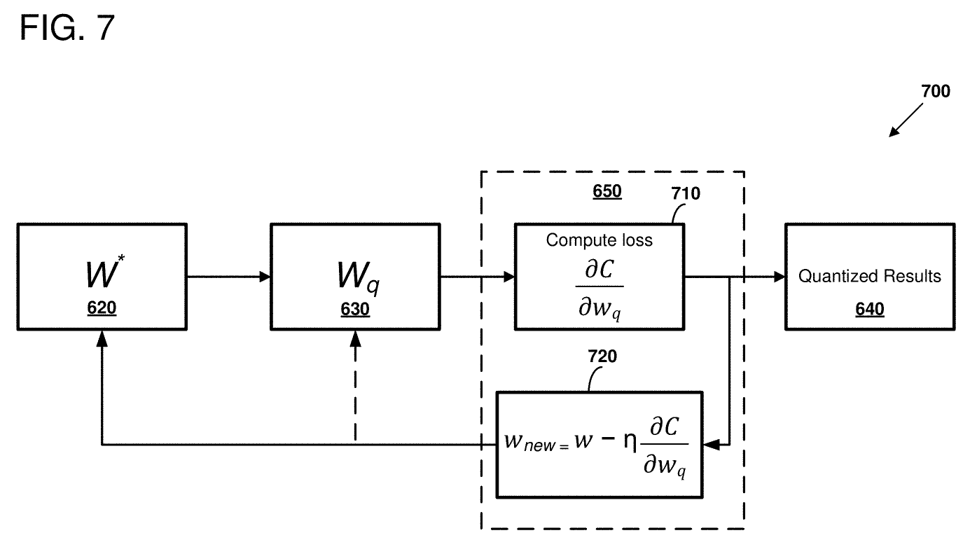

FIG. 7 is a diagram 700 further detailing aspects of quantized training, as can be performed in certain examples of the disclosed technology. For example, the illustrated quantized training can be used to implement the quantized training 650 discussed above regarding FIG. 6. As shown, a quantized floating-point model 630 is provided for quantized training. Loss is computed at 710 for forward-pass training using the quantized model 630. A gradient of the error is computed with respect to the quantized model 630. These accumulated gradients are used at 720 to provide updated values for the quantized floating-point model. During back propagation, a straight-through estimator is used for the gradients of the quantization operators. In other words, back-propagation is performed using identity operators instead of derivatives of the forward pass operation.

The fine-tuned quantized neural network model is used to produce quantized results 640. These results are evaluated to determine whether the quantized neural network model has sufficient accuracy for a particular application. If it is determined that the quantized model does not provide enough accuracy, even after performing quantized training, other steps can be taken to improve the network accuracy. For example, the bit width used to store mantissas or exponents in the quantized model can be increased. In some examples, different methods of assigning shared exponents can be used. For example, instead of using a single shared exponent for an entire array, multiple shared exponents may be used on a per-row, a per-column, or a per-tile basis. In some examples, it may be determined that certain portions of the neural network should be implemented with normal-precision floating-point using a general-purpose CPU in the final model, and only other portions of the neural network model are quantized and implemented using a hardware accelerator.

### X. Additional Aspects of Quantized Modeling

Parameters and methods of performing quantization can be varied in a number of different ways. For example, the number of bits used to represent a mantissa or an exponent can be varied. In some examples, a tensor is converted to a block floating-point format where at least two elements of the tensor share a single, common exponent. In some examples, in order to handle shared exponents over granulate finer than the entire tensor, the tensor can be reshaped or split into smaller tensors before applying quantization operations. Such reshaping allows for the operations to be applied independently along certain axes while splitting allows for the following operations to be applied independently for each of the split tensors.

In some examples, a shared exponent for a tensor or a split tensor can be selected in a number of different ways. For example, a shared exponent e for a group of values can be selected as the exponent of the largest absolute value m of the group of values (e.g., a vector) x:

m=max(abs(x))

After determining the largest absolute value for the group, the shared floating-point exponent of the value e_{shared} can be determined using the following relation:

e_{shared}=floor(log₂m)

In some examples, the shared exponent can be determined in other ways. For example, if some amount of overflow or underflow is acceptable for a particular application, an exponent not based on the largest absolute value for the group can be selected. For example, an exponent can be selected such that accuracy of the representation is improved overall, or according to another metric.

In some examples, the mantissa width can be selected for the selected shared exponent as follows. A floating-point number is re-scaled such that mantissa bits that will be kept in the block floating-point representation are expressed in the integer portion of the scale value. The scale value is then rounded to remove fractional bits, and then scaling is reversed. These operations can be expressed for a selected shared exponent e, sign and mantissa bits to be retained b, and a vector x of tensor values:

$$scale = {2}^{b - 2 - e}$$

$$x = x * scale$$

$$x = round ( x )$$

$$x = clip ( x , - {2}^{b - 1} + 1 , {2}^{b - 1} - 1 )$$

$$x = \frac{x}{scale}$$

In some examples, a quantization API or library can be provided to facilitate conversion of neural network tensors between normal-precision floating-point and quantized-precision format.

In some examples, interfaces to quantized operators are provided that replicate or closely match corresponding interfaces for a normal-precision floating-point library. A programmer can easily access the quantized operators by, for example, changing the name of a class used for function calls, or redefining or overloading methods of a class in an object oriented scheme.

A number of different quantization parameters can be selected. These include bit widths for node weights, for example 3, 4, or 5 bits for values; bit widths for input or activation values for a neural network, for example 3, 4, or 5 bits for representing values; a format to use for operators on non-quantized paths in the model (e.g., 16- or 32-bit floating-point); and/or parameters to specify quantized operation, for example a parameter to specify whether a one-dimensional or two-dimensional colonel should be flattened before quantization.

Additional parameters can be specified using a programming interface to control details of the quantization scheme. For example, the size of a tile or group of numbers that shares a particular single exponent, restricting exponent sharing to rows or columns for weights, or methods for selecting a shared exponent. For example, exponent sharing can be limited to rows of a tensor for activation values and columns of the tensor for weight values. As another example, the shared exponent selection method can be selection of the exponent of the absolute maximum value in the matrix, or another value based on statistical distribution of node values in the neural network.

### XI. Example Convolution Operations

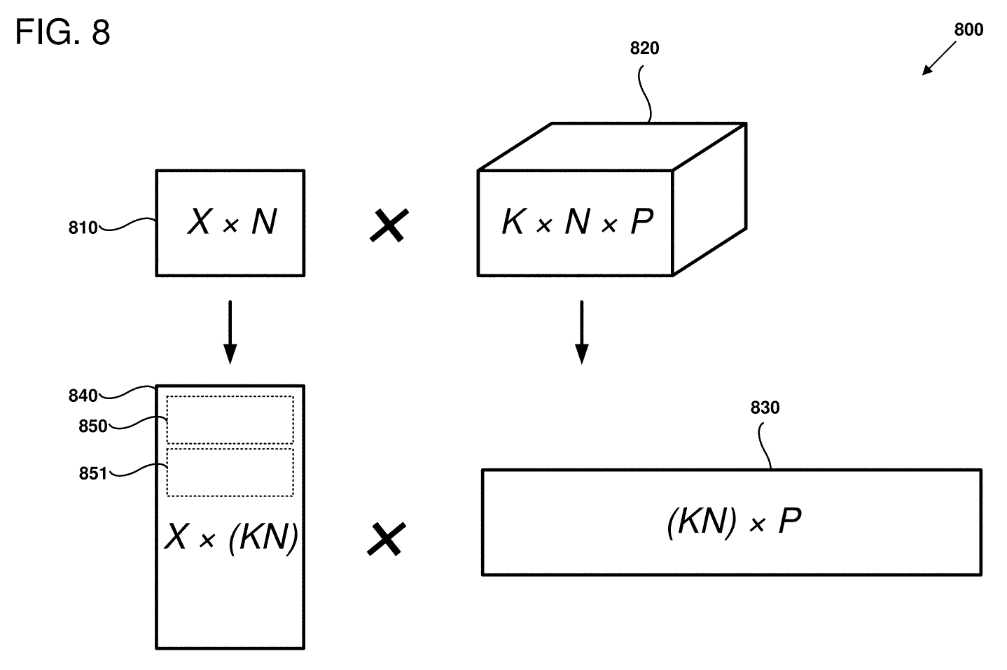

FIG. 8 is a diagram 800 illustrating an example of performing a one-dimensional convolution operation, as can be performed in certain examples of the disclosed technology. For example, operations performed on quantized models such as those discussed above regarding FIGS. 5-7 can include use of one-dimensional or two-dimensional convolutions.

For a one-dimensional convolution, a two-dimensional input tensor 810 (dimensions X, N, where N is the number of input channels) and a three-dimensional convolution kernel tensor 820 (dimensions K, N, P, where K is the kernel_size, N is the number of input channels, and P is the number of output channels) are provided as quantized matrices. The convolution kernel is “flattened” into a 2-D matrix 830 with two dimensions (K·N and P). The input is converted into a 2-D matrix 840 where each row (e.g., rows 850 or 851) is a K·N window of the original input. Quantization is applied to each of these matrices, with a selected tiling of their respective shared exponents. For example, the fourth format 470 may be applied to achieve a selected level of accuracy and computational effort.

For a two-dimensional convolution, a similar procedure as for the one-dimensional convolution illustrated in FIG. 8 can be used. For example a three-dimensional input tensor (X, Y, N) can have an operation applied using a four-dimensional convolution kernel (K, L, N, and P). The input is flattened into a two-dimensional matrix where each row is a K·L·N window of the original input tensor. The convolutional kernel is flattened into a two-dimensional matrix having dimensions (K·L·N and P). as with the one-dimensional convolution discussed above, quantization can be applied to each of these matrices using selected quantization parameters. For example, the fourth format 470 may be applied to achieve a selected level of accuracy and computational effort.

In alternate examples, where the number of input channels is equal to the tile size, convolution may be performed without flattening the kernels. Instead, an exponent is shared per pixel of the kernels. For the input tensor this is an exponent per input. This can also be performed in a similar fashion when the number of input channels is greater than the tile size by limiting exponents to vectors in each pixel having a length equal to the tile size. This can be applied when the number of input channels is less than tile size by padding out the pixels to the tile size with a constant value for example 0 or a one. This may be desirable in some applications, as flattening convolutions for matrix multiplication incurs an additional cost.

### XII. Example Method of Performing Operations Using Ouantized-Format Numbers

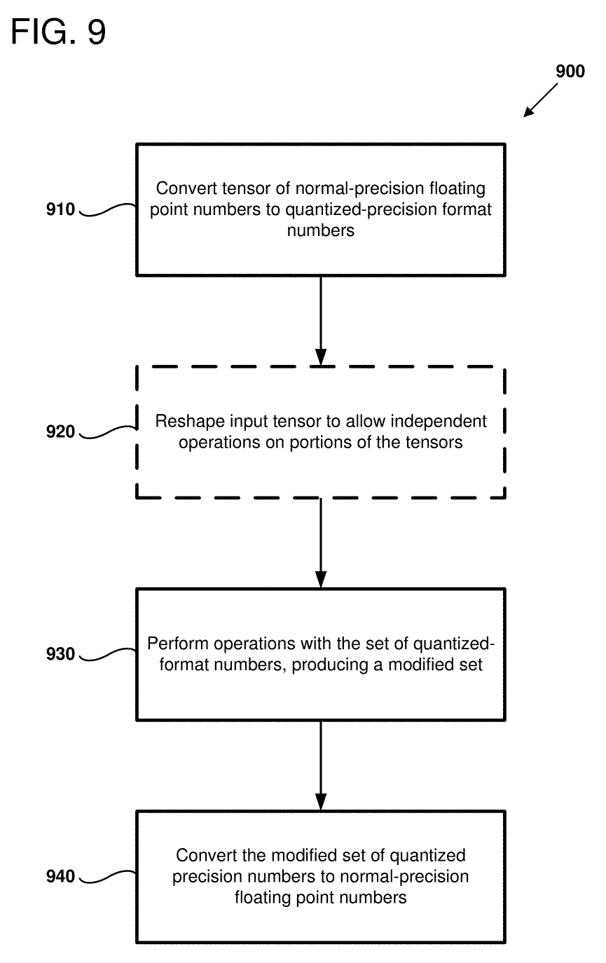

FIG. 9 is a flow chart 900 outlining an example method of performing operations with quantized format numbers, as can be performed in certain examples of the disclosed technology. For example, neural network modeling and evaluation can be performed using quantized format operations in order to evaluate performance trade-offs in a general purpose processor environment, prior to mapping a neural network to a hardware accelerator.

At process block 910, a tensor of normal precision floating-point numbers is converted to a set of quantized precision format numbers. Aspects of the conversion can include adjusting bit widths used represent mantissas or exponents, selecting a single shared exponent that is shared by two or more values in the tensor, or other suitable quantization operations disclosed herein. And some examples, the input tensor is generated by training a neural network, and the normal precision floating-point numbers represent node weights, input weights, or activation weights for a neural network.

At process block 920, input tensors are reshaped to allow for independent operations on portions of the tensor. Because restricting exponent sharing to a tile, column, or row of a matrix can reduce quantization error, it may be desirable in some applications to restrict exponent sharing to selected tiles, columns, or rows of a tensor matrix. The tensor can be reshaped such that the number of values along the reduction axis is limited. For example, for a one-dimensional vector of length 1024, exponent sharing may be reduced to 128 values. This vector can be reshaped to have dimensions 128×8. Next, a shared exponent calculation is performed across the axis, producing eight shared exponents, or one shared exponent for each set of 128 values. As will be readily understood to one of ordinary skill in the art having the benefit of the present disclosure, similar reshaping operations can be adapted depending on the dimensions of the input vector, a kernel used to apply operations to the input, or other suitable aspects for the particular model. As indicated by the dashed lines, the operations performed at process block 920 may be omitted in certain examples of the method, in which case the method proceeds to process block 930, without reshaping. The reshaping of the input tensor can allow independent operations to be performed on portions of the tensor, for example individual columns or rows. In some examples, the reshaping is performed by flattening a convolution will kernel from four dimensions into three dimensions, from three dimensions into two dimensions, or from two dimensions into one dimension.

At process block 930, operations are performed with the set of quantized format numbers, to produce a modified set of quantized precision format numbers. The quantized precision format can be in a block floating-point format were at least two elements of the set of quantized precision format numbers share a common exponent. In some examples, a block floating-point format has at least two but not all of two columns, to rows, two tiles, two columns of a tile, or to rows of a tile sharing a common exponent. In some examples, performing the operations includes performing inference operations with a quantized neural network. In some examples, additional training may be performed as part of the operations. For example, additional training can be performed by calculating loss of a neural network using the quantized precision format values and updating either the quantized precision values or the normal precision format model based on a gradient calculated based on the calculated loss for the neural network.

At process block 940, the modified set of quantized precision operators are converted to normal precision floating-point numbers. In some examples, the normal precision floating-point format can be a 16-bit, 32-bit, 64-bit, or an 80-bit floating-point format.

### XIII. Example Method of Training Quantized Neural Networks

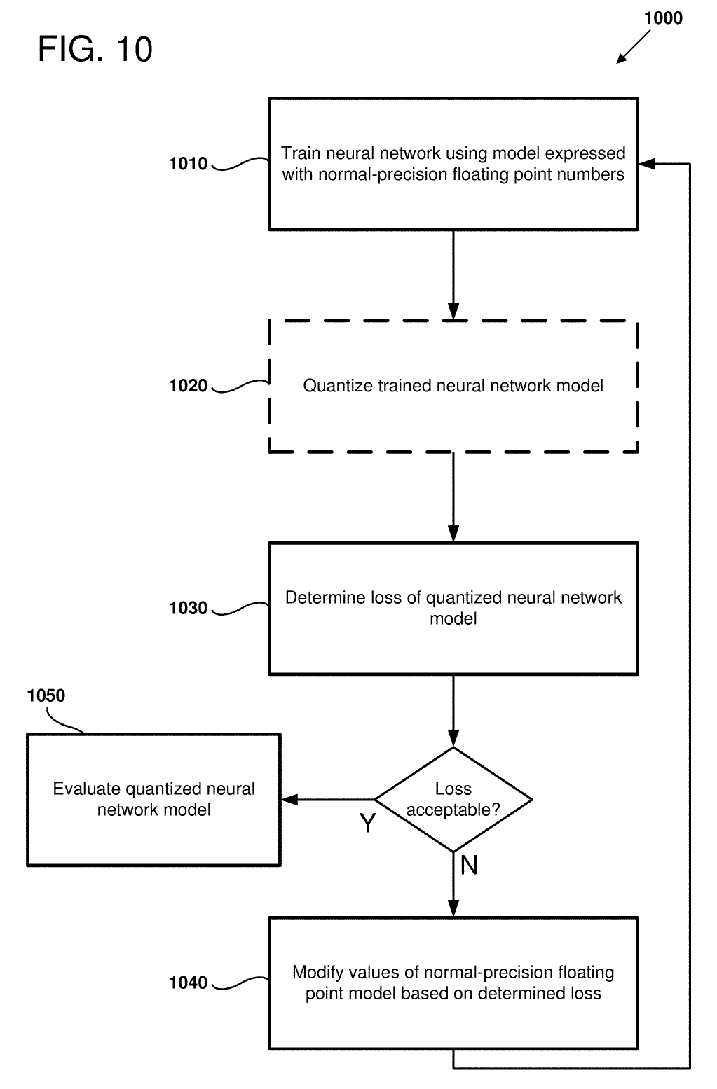

FIG. 10 as a flowchart 1000 outlining an example method of training a neural network using a quantized precision floating-point format, as can be used in certain examples of the disclosed technology. For example, the quantization-enabled emulation system discussed above regarding figure one can be used to implement the illustrated method.

At process block 1010, a neural network is trained using a model expressed using normal precision floating-point numbers. For example, stochastic gradient descent training is an example of a suitable technique that can be used to train the neural network. The trained network is provided to a quantized programming interface by an applications programming interface, by providing additional functions or methods that can be called by the programmer, or by other suitable techniques. By providing a programming interface that closely matches a programming interface or function/method definitions used for a normal precision floating-point format, modeling the neural network and a quantized environment can be facilitated.

At process block 1020, the trained neural network model is quantized. For example, the bit width selected to represent exponents or mantissas can be adjusted, or a block floating-point format can be used to represent at least a portion of the trained neural network model. In some examples, some portions of a neural network model may be exclusively modeled using only normal precision floating-point.

At process block 1030, loss is determined for the quantized neural network model. This can be done by, for example, comparing output values produced by the quantized model to output values produced using the same model expressed in a normal precision format. In other examples, the loss can be turned determined at least in part by comparing results achieved using the quantized model to that achieved with a normal precision format model. The results are evaluated against a predetermined metric to determine whether the loss induced by using a quantized network model will be acceptable. If it is determined that the loss is not acceptable, then the method proceeds to process block 1040.

At process block 1040, values of the normal precision floating-point model are modified based on the determined loss. For example, a gradient can be calculated and associated node weights, input weights, and/or activation values can be adjusted based on the gradient. After modifying the values, the neural network is further trained using the model, and re-quantized. In other examples, the modified values can be applied directly to the quantized neural network model.

At process block 1050, the quantized neural network model is evaluated. For example, accuracy of the neural network can be compared to neural network models expressed using normal precision formats, or to other models in quantized formats, and in particular, quantized formats having at least one different parameter than the subject quantized neural network model.

### XIV. Example Computing Environment

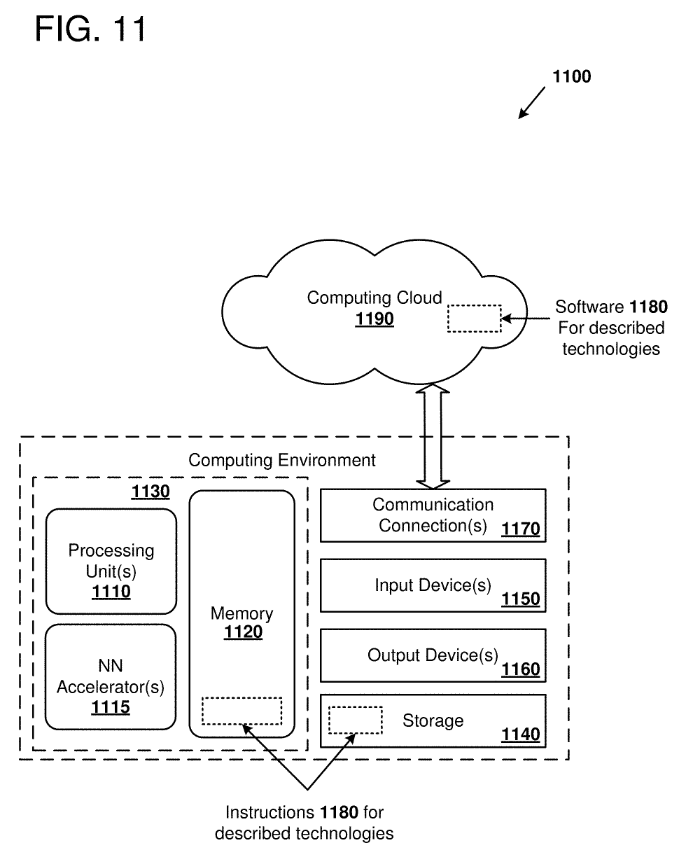

FIG. 11 illustrates a generalized example of a suitable computing environment 1100 in which described embodiments, techniques, and technologies can be implemented. For example, the computing environment 1100 can implement disclosed techniques for configuring a processor to implement disclosed software architectures and neural networks, and/or compile code into computer-executable instructions and/or configuration bitstreams for performing such operations including neural networks, as described herein.

The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 11, the computing environment 1100 includes at least one processing unit 1110, an optional neural network accelerator 1115, and memory 1120. In FIG. 11, this most basic configuration 1130 is included within a dashed line. The processing unit 1110 executes computer-executable instructions and may be a real or a virtual processor. In a multi-processing system, multiple processing units execute computer-executable instructions to increase processing power and as such, multiple processors can be running simultaneously. The accelerator 1115 can include a Tensor Processing Unit (TPU) and/or reconfigurable logic devices, such as those contained in FPGAs or a programmable circuit fabric. The memory 1120 may be volatile memory (e.g., registers, cache, RAM), non-volatile memory (e.g., ROM, EEPROM, flash memory, etc.), or some combination of the two. The memory 1120 stores software 1180, images, and video that can, for example, implement the technologies described herein. A computing environment may have additional features. For example, the computing environment 1100 includes storage 1140, one or more input device(s) 1150, one or more output device(s) 1160, and one or more communication connection(s) 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which can be used to store information and that can be accessed within the computing environment 1100. The storage 1140 stores instructions for the software 1180, which can be used to implement technologies described herein.

The input device(s) 1150 may be a touch input device, such as a keyboard, keypad, mouse, touch screen display, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, CD-writer, or another device that provides output from the computing environment 1100.

The communication connection(s) 1170 enable communication over a communication medium (e.g., a connecting network) to another computing entity. The communication medium conveys information such as computer-executable instructions, compressed graphics information, video, or other data in a modulated data signal. The communication connection(s) 1170 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed methods. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1190. For example, disclosed compilers, processors, and/or neural networks are implemented with servers located in the computing environment, or the disclosed compilers, processors, and/or neural networks can be implemented on servers located in the computing cloud 1190. In some examples, the disclosed compilers execute on traditional central processing units (e.g., RISC or CISC processors), central processing units extended to include vector processing instructions, or vector processors.

Computer-readable media are any available media that can be accessed within a computing environment 1100. By way of example, and not limitation, with the computing environment 1100, computer-readable media include memory 1120 and/or storage 1140. As used herein, the term computer-readable storage media includes all tangible media for data storage such as memory 1120 and storage 1140, but not transmission media such as modulated data signals.

### XV. Experimental Results

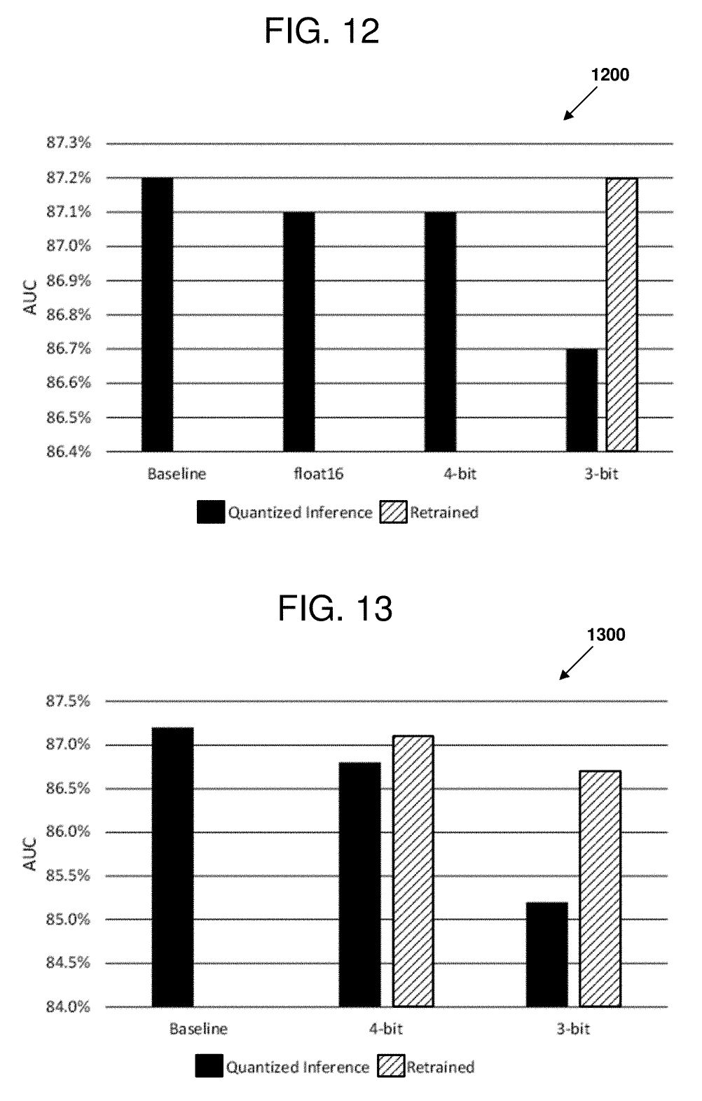

FIGS. 12-16 are a series of charts illustrating experimental results observed when using quantized floating-point neural networks in comparison to corresponding models implemented using normal-precision floating-point.

FIG. 12 is a chart 1200 illustrating accuracy measured for a test neural network model implemented using various levels of quantization for Gated Recurrent Units (GRUs) within a neural network. As shown, and accuracy level of 87 point 2% is achieved with a baseline version of the test neural network model. Very little accuracy is lost when the baseline version is converted from 32-bit to a 16-bit floating-point format. Similarly, when the neural network is quantized to a four-bit block floating-point model, a similar level of accuracy as a 16-bit floating-point model is achieved. Results for a three-bit block floating-point model have the lowest accuracy depicted in the chart 1200. However, after applying a disclosed method of quantized retraining, the three-bit block floating-point model achieves a similar level of accuracy as the baseline model.

FIG. 13 is a chart 1300 illustrating accuracy measured for a test neural network model implemented using various levels of precision or quantization for both convolution kernels and GRUs within a neural network. As shown, some accuracy drop-off is seen going from the baseline model to a four-bit block floating-point model and to a three-bit block floating-point model. However, when quantized training as applied, the accuracy observed for both the four-bit models and the three-bit models approaches that of the baseline neural network model.

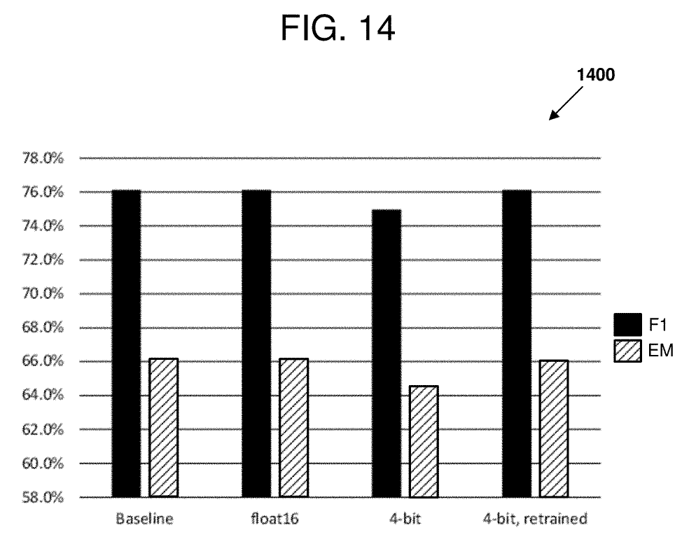

FIG. 14 is a chart 1400 depicting results for a neural network where long short-term memory nodes (LSTMs) are quantized. As shown, essentially no accuracy loss is observed after retraining a four-bit quantized block floating-point format. Approximately one percent accuracy loss is observed when using a three-bit quantized block floating-point format. The data series labeled “EM” represent the percentage of trials where the output of the neural network matches a ground truth answer for the neural network exactly. The data series labeled “Fl” is a macro-average score for the output of the neural network.

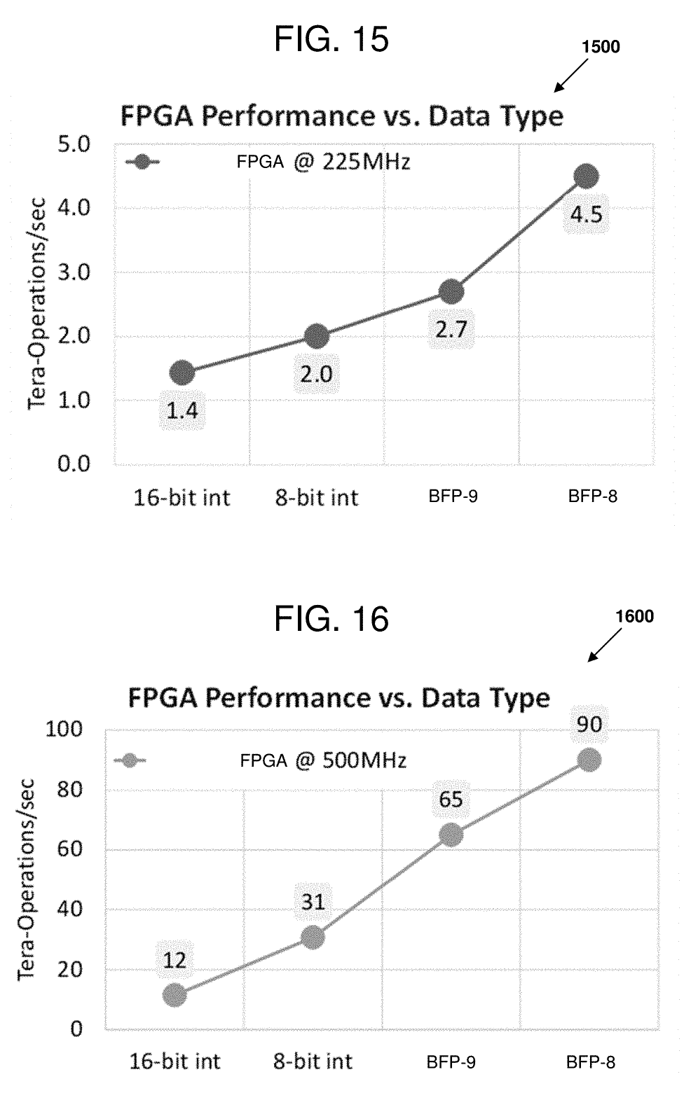

FIG. 15 is a chart 1500 depicting neural network performance as measured in Tera-operations per second achieved with a commercially available FPGA operating at 225 MHz. As shown, four floating-point formats are charted: a 16-bit fixed point format, and 8-bit fixed point format, a block floating-point format (BFP-9), which has one sign bit, five exponent bits, and three mantissa bits and a second block floating-point format (BFP-8), which has one sign bit, five exponent bits, and two mantissa bits. FIG. 16 is a chart 1600 depicting neural network performance achieved with another commercially available if PGA operating at 500 MHz. Therefore, by providing modeling and programming tools for optimizing quantized format neural network tensors on a general purpose computing platform, improved performance can be achieved after mapping the optimized quantized format neural network to a hardware accelerator. Such performance gains would not be as readily achieved without tools disclosed herein, based on, for example, reduced programmer productivity and effort required to understand tradeoffs in selecting various quantization parameters for a hardware accelerator. Hence, improved programmer productivity and ultimately improved hardware acceleration can be achieved using certain disclosed methods and apparatus.

### XVI. Additional Examples of the Disclosed Technology

Additional examples of the disclosed technology are disclosed in accordance with the examples above.

In some examples of the disclosed technology, a computer-implemented method of emulating quantized neural networks includes, by a general purpose processor, converting an input tensor of normal-precision floating-point numbers to a set of numbers represented in a quantized-precision format, at least one parameter of the format being selected to emulate a quantized hardware accelerator for processing a neural network comprising the input tensor, performing at least one operation with the set of quantized-precision format number, producing a modified set of quantized-precision format numbers, and converting the modified set of quantized-precision format numbers to an output tensor of numbers in the normal-precision floating-point format.

In some examples, the quantized-precision format is a block floating-point format where at least two elements of the set of quantized-precision format numbers share a common exponent. In some examples, the quantized-precision format is a block floating-point format where at least two but not all of two columns, two rows, two tiles, two columns of a tile, or two rows of a tile share a common exponent. In some examples, the mantissas in the block floating point format are 3, 4, 5, 6, 7, or 8 bits wide. In some examples, the shared exponent can be 3, 4, 5, 6, 7, or 8 bits wide. In some examples, the method further includes generating the input tensor of normal-precision floating-point numbers by training a neural network, the set of normal-precision floating-point numbers representing at least one of edge weights or activation weights for the neural network, and the performing at least one operation includes performing normal-precision format operations on the quantized-precision format numbers. In some examples, converting the input tensor includes identifying a shared exponent for a selected at least two elements of the input tensor, scaling values of the input tensor so that the integer portion of the scaled mantissas has a selected number of bits for the quantized precision format, removing fractional bits from the scaled integer portion of the mantissa, and rounding the mantissa to produce a quantized precision value. In some examples, tensors can be one-dimensional arrays (vectors), two-dimensional arrays, three-dimensional arrays, or four-dimensional arrays.

In some examples, methods further include reshaping the input tensor to allow the converting the input tensor to include independent operations on portions of the input tenor. In some examples, the input tensor represents a portion of a previously-trained neural network and performing at least one operation comprises performing inference operations with the quantized neural network. Methods can further include comparing output of the neural network based on the inference operations to output of the previously-trained neural network in the flowing point format.

In some examples, the input tensor represents a portion of a neural network. In some examples, the method further includes calculating loss of a neural network using the set of quantized-precision format numbers and updating the modified set of quantized-precision format numbers based on a gradient calculated based on the calculated loss of the neural network.

In some examples of the disclosed technology, a neural network comprising tensors representing node weights, activation values, biases, and/or edges is modeled by a quantization-enabled system. The system can include memory, one or more processors coupled to the memory, and one or more computer readable storage media storing computer-readable instructions that when executed by the at least one processor, cause the system to perform a method of evaluating the neural network. The instructions can include instructions that cause the system to evaluate the neural network having its node weights and edges stored in the memory as a normal-precision floating-point format, instructions that cause the system to convert at least one of the tensors to values expressed in a quantized-precision format, instructions that cause the system to perform at least one mathematical operation with the at least one of the quantized tensors, producing modified tensors, and instructions that cause the system to convert the modified tensors to a normal-precision floating-point format.

In some examples of the apparatus, the quantized-precision format is a block floating-point format where at least two but not all of two columns, two rows, two tiles, two columns of a tile, or two rows of a tile share a common exponent. In some examples, the mantissas in the block floating point format are 3, 4, 5, 6, 7, or 8 bits wide. In some examples, the shared exponent can be 3, 4, 5, 6, 7, or 8 bits wide. In some examples, the system can generate the input tensor of normal-precision floating-point numbers by training a neural network, the set of normal-precision floating-point numbers representing at least one of edge weights or activation weights for the neural network, and the performing at least one operation includes performing normal-precision format operations on the quantized-precision format numbers. In some examples, converting the input tensor includes identifying a shared exponent for a selected at least two elements of the input tensor, scaling values of the input tensor so that the integer portion of the scaled mantissas has a selected number of bits for the quantized precision format, removing fractional bits from the scaled integer portion of the mantissa, and rounding the mantissa to produce a quantized precision value. In some examples, tensors can be one-dimensional arrays (vectors), two-dimensional arrays, three-dimensional arrays, or four-dimensional arrays. In some examples, the mathematical operation is performed with the quantized values stored in a normal-precision floating-point format. In some examples, the mathematical operation is performed by emulating quantized operations with the quantized values.

In some examples, the modified tensors represent all or a portion of a quantized neural network. In some examples, the instructions to perform the at least one mathematical operation also include instructions that cause the system to perform quantized training of the quantized neural network to produce the modified tensors. In some examples, the instructions cause the system to program a neural network accelerator with quantized values determined based on executing the instructions to convert the tensors, to perform the at least one mathematical operation, and/or to convert the modified tensors to the normal-precision floating-point format. In some examples, the accelerator is a TPU. In some examples, the accelerator is an FPGA.

In some examples of the disclosed technology, one or more computer-readable storage media store computer-readable instructions that when executed by a processor, cause the processor to perform a method of using an application programming interface for performing operations in a quantized precision format. In some examples, the instructions include instructions that cause the processor to: specify at least one parameter of the quantized precision format, convert a normal precision format tensor to the quantized precision format, provide at least one tensor operation in the quantized precision format, and convert an output of the at least one tensor operation to the normal precision format

In some examples, the at least one parameter is for a neural network represented in the quantized precision format, the at least one parameter including at least one of the following: a bit width of node weights, a bit width of activation values, a floating-point format for performing non-quantized operations, a tile size for a shared exponent, a parameter to share an exponent on a per-row basis, a parameter to share an exponent on a per-column basis, and/or a parameter specifying a method of common exponent selection.

In some examples, the instructions further include instructions a parameter to specify flattening a tensor prior to quantization. In some examples, the instructions include instructions that cause the processor to provide a class method defining a quantized matrix multiplication operation.

In some examples of the disclosed technology, the normal-precision floating-point format is one of the following: a 16-bit floating-point format, a 32-bit floating-point format, a 64-bit floating-point format, or an 80-bit floating-point format.

In some examples, at least one input tensor has two dimensions X and N, and performing at least one operation includes applying a convolution kernel having three dimensions K, N, and P to the input tensor, flattening the convolution kernel into a two-dimensional matrix having two dimensions K×N and P; and converting the input tensor into a matrix having two dimensions K×N and X.

In some examples, at least one input tensor has three dimensions X, Y, and N, and the performing the at least one operation includes applying a convolution kernel having four dimensions K, L, N, and P to the input tensor. In some examples, applying a convolution kernel includes flattening the input tensor into a two-dimensional matrix having two dimensions N×M and K, and converting the input tensor into a matrix having two dimensions K×L×N and M.

In some examples, one or more computer-readable storage media storing computer-executable instructions that when executed by a computer, cause the computer to perform the any one of the disclosed methods.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims.

What is claimed is:

1. A method comprising:
by a processor, converting an input tensor of normal-precision floating-point numbers to a set of numbers represented in a quantized-precision format, at least one parameter of the the format being selected to emulate a quantized hardware accelerator for processing a neural network comprising the input tensor;
by the processor, performing at least one operation with the set of quantized-precision format number, producing a modified set of quantized-precision format numbers; and
converting the modified set of quantized-precision format numbers to an output tensor of numbers in the normal-precision floating-point format.

2. The method of claim 1, wherein:
the quantized-precision format is a block floating-point format where at least two elements of the set of quantized-precision format numbers share a common exponent.

3. The method of claim 1, wherein:
the quantized-precision format is a block floating-point format where at least two but not all of two columns, two rows, two tiles, two columns of a tile, or two rows of a tile share a common exponent.

4. The method of claim 1, further comprising:
generating the input tensor of normal-precision floating-point numbers by training a neural network, the set of normal-precision floating-point numbers representing at least one of edge weights or activation weights for the neural network, wherein:
the performing at least one operations comprises performing normal-precision format operations on the quantized-precision format numbers.

5. The method of claim 1, wherein the converting the input tensor comprises:
identifying a shared exponent for a selected at least two elements of the input tensor;
scaling values of the input tensor so that the integer portion of the scaled mantissas has a selected number of bits for the quantized precision format;
removing fractional bits from the scaled integer portion of the mantissa; and
rounding the mantissa to produce a quantized precision value.

6. The method of claim 1, further comprising:
reshaping the input tensor to allow the converting the input tensor to include independent operations on portions of the input tenor.

7. The method of claim 1, wherein:
the input tensor represents a portion of a previously-trained neural network,
the performing at least one operation comprises performing inference operations with the quantized neural network; and
the method further comprises:
comparing output of the neural network based on the inference operations to output of the previously-trained neural network in the flowing point format.

8. The method of claim 1, wherein the input tensor represents a neural network, and wherein the method further comprises:
calculating loss of a neural network using the set of quantized-precision format numbers; and
updating the modified set of quantized-precision format numbers based on a gradient calculated based on the calculated loss of the neural network.

9. The method of claim 1, wherein:
the normal-precision floating-point format is one of the following: a 16-bit floating-point format, a 32-bit floating-point format, a 64-bit floating-point format, or an 80-bit floating-point format.

10. The method of claim 1, wherein: the input tensor has two dimensions X and N, the performing the at least one operation comprises applying a convolution kernel having three dimensions K, N, and P to the input tensor, the method further comprising:
flattening the convolution kernel into a two-dimensional matrix having two dimensions K×N and P; and
converting the input tensor into a matrix having two dimensions K×N and X.

11. The method of claim 1, wherein: the input tensor has three dimensions X, Y, and N, the performing the at least one operation comprises applying a convolution kernel having four dimensions K, L, N, and P to the input tensor, the method further comprising:
flattening the input tensor into a two-dimensional matrix having two dimensions N×M and K; and
converting the input tensor into a matrix having two dimensions K×L×N and M.

12. A quantization-enabled system for modeling a neural network comprising tensors representing node weights and edges, the system comprising:
memory;
one or more processors coupled to the memory;
one or more computer readable storage media storing computer-readable instructions that when executed by the at least one processor, cause the system to perform a method of evaluating the neural network, the instructions comprising:
instructions that cause the system to evaluate the neural network having its node weights and edges stored in the memory as a normal-precision floating-point format;
instructions that cause the system to convert at least one of the tensors to values expressed in a quantized-precision format;
instructions that cause the system to perform at least one mathematical operation with the at least one of the quantized tensors, producing modified tensors; and
instructions that cause the system to convert the modified tensors to a normal-precision floating-point format.

13. The system of claim 12, wherein:
the mathematical operation is performed with the quantized values stored in a normal-precision floating-point format.

14. The system of claim 12, wherein:
the mathematical operation is performed by emulating quantized operations with the quantized values.

15. The system of claim 12, wherein the modified tensors represent a quantized neural network, and wherein the instructions to perform the at least one mathematical operation further comprise:
instructions that cause the system to perform quantized training of the quantized neural network to produce the modified tensors.

16. The system of claim 12, wherein the instructions further comprise:
instructions to program a neural network accelerator with quantized values determined based on executing the instructions to convert the tensors, to perform the at least one mathematical operation, and/or to convert the modified tensors to the normal-precision floating-point format.

17. One or more computer-readable storage media storing computer-readable instructions that when executed by a processor, cause the processor to perform a method of using an application programming interface for performing operations in a quantized precision format, the instructions comprising:
instructions that cause the processor to specify at least one parameter of the quantized precision format;
instructions that cause the processor to convert a normal precision format tensor to the quantized precision format;
instructions that cause the processor to provide at least one tensor operation in the quantized precision format; and
instructions that cause the processor to convert an output of the at least one tensor operation to the normal precision format.

18. The computer-readable storage media of claim 17, wherein the at least one parameter is for a neural network represented in the quantized precision format, the at least one parameter including at least one of the following: a bit width of node weights, a bit width of activation values, a floating-point format for performing non-quantized operations, a tile size for a shared exponent, a parameter to share an exponent on a per-row basis, a parameter to share an exponent on a per-column basis, and/or a parameter specifying a method of common exponent selection.

19. The computer-readable storage media of claim 17, wherein the computer-readable instructions further comprise a parameter to specify flattening a tensor prior to quantization.

20. The computer-readable storage media of claim 17, wherein the computer-readable instructions further comprise:
instructions to provide a class method defining a quantized matrix multiplication operation.
